(19) United States
(12) Patent Application Publication
(10) Pub. No.: US 2007/0272086 A1
(43) Pub. Date: Nov. 29, 2007

(54) Moka Coffee Pot

(75) Inventor: Enrico Ancona, Roma (IT)

Correspondence Address: HAHN & VOIGHT PLLC, 1012 14TH STREET, NW, SUITE 620, WASHINGTON, DC, 20005, US

(73) Assignee: IMPERIA S.P.A., Roma (IT)

(21) Appl. No.: 11/570,757

(22) PCT Filed: Jun. 15, 2005
(86) PCT No.: PCT/IB05/01675

§ 371 Date: Dec. 15, 2006

(30) Foreign Application Priority Data
Jun. 17, 2004 (IT) TO2004U000080
Jun. 17, 2004 (IT) TO2004A000405

(51) Int. Cl. A47J 31/00; A47J 31/16; A47J 31/40

(52) U.S. Cl. 99/287; 99/288

(57) ABSTRACT

The coffee pot, according to the invention, comprises a chimney conduit (18) laterally offset in the upper vessel (12) relative to the axis (X-X) of the coffee pot (10). In the coffee a tortuous path is thus formed, starting from an orifice (15.1), in which the boiling water under pressure enters and arrives, through an axial tube (15), in the chamber (14) of a funnel filter (13), where it impregnates and flows through the coffee powder and a disk-shaped filter (17), forming in an infusion chamber (17.1) the coffee infusion, which then rises under pressure through said offset chimney conduit (18), until its outlet (18.1), from which it spills into the upper vessel (12).

The present invention relates to a moka coffee pot for home use.

A known moka coffee pot essentially comprises two superposed vessels, mutually joined by screwing at the smaller bases. The lower vessel contains water and serves as a boiler. It houses a funnel filter, having an upper, cup-shaped chamber, whose bottom is perforated and in which is contained some coffee powder. A tube extends downwards from the bottom of the cup-shaped chamber, aligned with the median vertical of the two superposed vessels (vertical which hereinafter, for the sake of brevity, is called axis of the coffee pot), and has an orifice positioned in proximity to the bottom for the entrance of the boiling water under pressure. The upper vessel, serving as a container for collecting the brew, is provided with a chimney conduit, into which flows the brew under pressure which comes from the boiler through the funnel filter. Said chimney conduit has an outlet, positioned in the top part of the upper vessel, and develops, starting from the bottom of the vessel, along the axis of the coffee pot. A pressure-tight annular gasket, e.g. made of elastomeric material, is provided between the two mutually screwed vessels, which are made, e.g., of duralumin. Between the gasket and the bottom of the upper vessel is positioned a perforated disk-shaped filter, which maintains the coffee powder in the cup of the funnel filter, while it forms an infusion chamber with the bottom of the upper vessel. Funnel filter and disk-shaped filter are made, for example, of aluminium. In this arrangement, the funnel filter and the chimney conduit are aligned with each other and with the axis of the coffee pot.

With this known coffee pot, the coffee drink is prepared in the following manner: the water, brought to a boil in the boiler and kept boiling under pressure, arrives through the axial tube into the chamber of the funnel filter, where it impregnates and flows through the coffee powder and the disk-shaped filter, forming the infusion in the infusion chamber. The infusion under pressure rises in the axial chimney conduit up to its outlet, from which it spills into the upper vessel, where the ready drink is collected. The path of the water under pressure that enters the orifice of the tube of the funnel filter, then transforming itself into a coffee infusion that flows out of the outlet of the chimney conduit, is substantially rectilinear vertical and, therefore, the liquid under pressure does not linger in the cup-shaped filter and in the infusion chamber, but flows through them rapidly. In this way, the liquid under pressure achieves only a partial extraction of the aromas of the coffee powder, to the detriment of the organoleptic properties of the coffee infusion thereby obtained.

Moreover, during the extraction of the infusion, jets of boiling liquid spray in all directions from the outlet of the chimney conduit, and when the lid is even partially open they can spray out of the coffee pot.

On the other hand, the coffee infusion collected in the upper vessel tends to have differentiated density, i.e. greater towards the bottom, where the micro-powders in suspension in the infusion tend to settle, and this is also due to the different concentration in aromas extracted from the coffee powder present in the part of infusion that spills first from the chimney conduit. This drawback is significant in coffee pots in which the infusion is prepared for multiple coffee cups. The first cup of infusion poured from the coffee pot has sharply different organoleptic properties from those of the last cup of infusion poured from the same coffee pot.

The present invention, starting from the awareness of said drawbacks, is aimed at overcoming them.

The main object of the present invention is to provide a moka coffee pot for home use, which allows to obtain, for the same mix and dosage of water and coffee powder, an infusion with improved organoleptic properties with respect to the infusion obtained with a conventional moka coffee pot.

Another object of the invention is to provide a coffee pot as specified, which allows to pour an infusion with equivalent organoleptic properties from the first to the last cup.

A further object of the invention is to provide a coffee pot as specified which has simplified structure and safe and reliable operation.

In view of said objects, the present invention provides a moka coffee pot for home use, whose essential characteristic is set out in claim 1.

Additional advantageous characteristics are set out in the dependent claims.

The aforesaid claims are understood to be fully incorporated herein.

The present invention shall become readily apparent from the detailed description that follows, with reference to the accompanying drawings provided purely by way of example, in which:

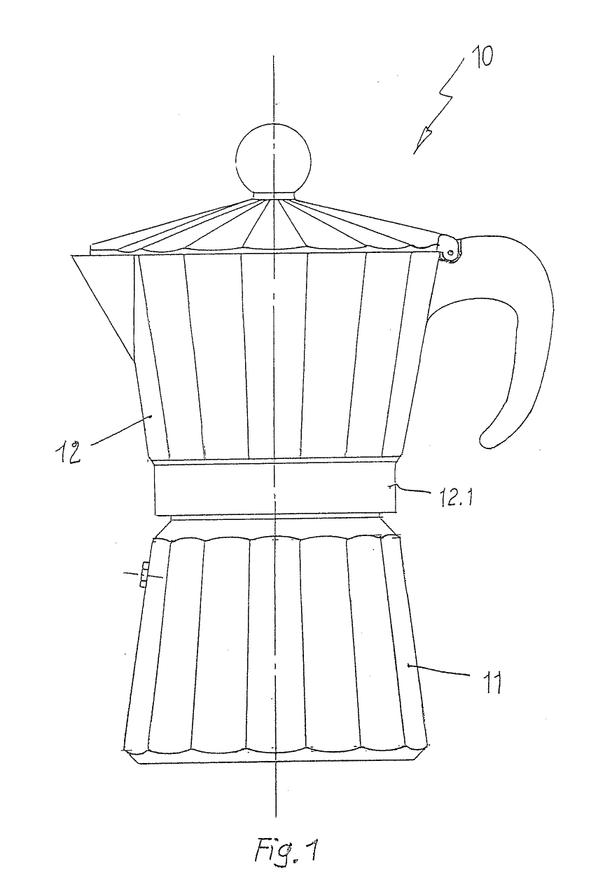

FIG. 1 is an elevation view of the moka coffee pot for home use, according to the present invention;

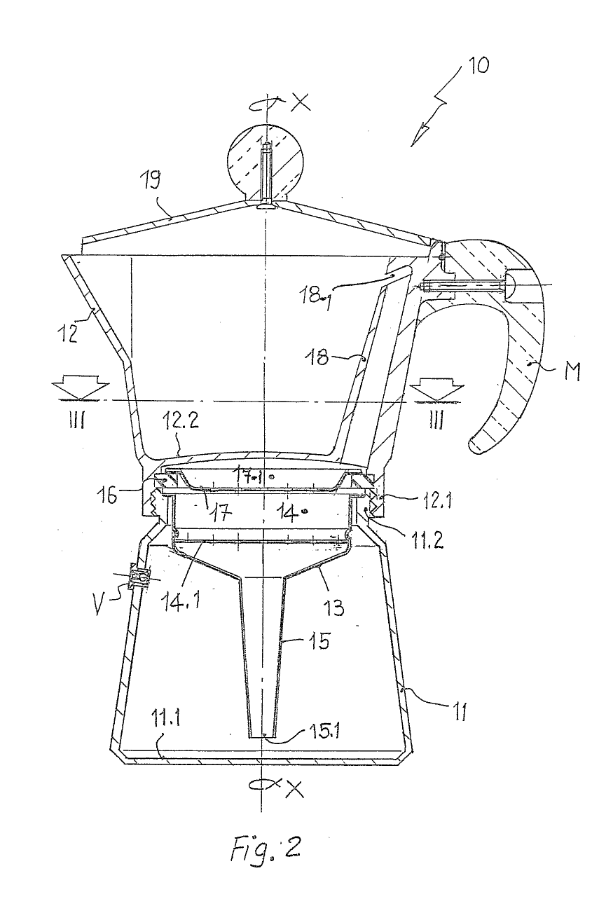

FIG. 2 is a vertical section view of the coffee pot of FIG. 1;

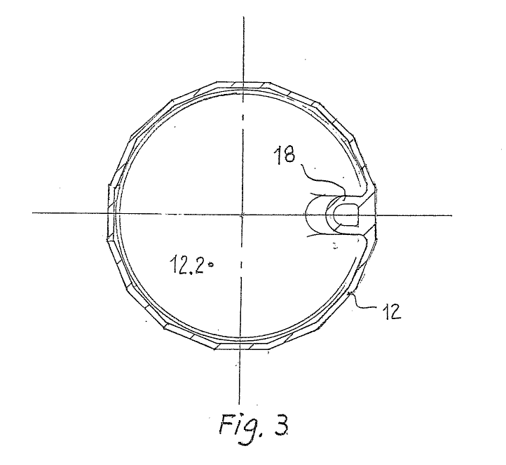

FIG. 3 is a section view according to the line III-III of FIG. 2;

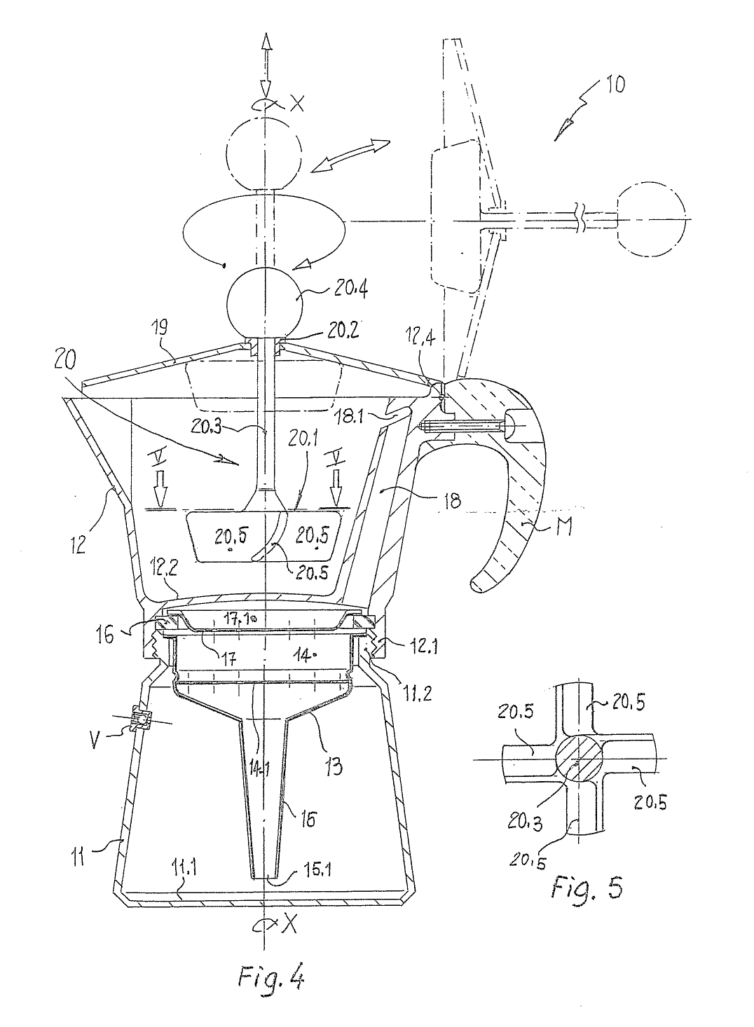

FIG. 4 is a vertical section view of the coffee pot of FIG. 1, in which, however, a mixer device is provided in the upper vessel;

FIG. 5 is a section view according to the line V-V of FIG. 4.

With reference to FIGS. 1 through 3 of the drawings, the reference number 10 globally designates the coffee pot for home use according to the present invention. Said coffee pot 10 comprises to superposed vessels, 11, 12, each with a general pyramid frustum shape.

The lower vessel 11 contains water and serves as a boiler. It is shaped as a right pyramid frustum and it houses a funnel filter 13, having an upper, cup-shaped chamber 14, whose bottom 14.1 is perforated and in which some coffee powder can be contained. A tube extends 15 downwards from the bottom of the cup-shaped chamber 14, aligned with the median vertical of the two superposed vessels (vertical denoted by X-X in FIG. 2 and hereinafter, for the sake of brevity, called axis of the coffee pot), and it has an orifice 15.1 for the entrance of the boiling water under pressure, positioned in proximity to the bottom 11.1 of the vessel 11.

The upper vessel 12 serves as a container for collecting the infusion and is shaped as an inverse pyramid frustum.

The two vessels 11, 12, which are made for example of duralumin, are mutually screwed by means of respective cylindrical integral collars: one, 11.2, extending upwards from the upper base of the lower vessel 11, and the other one, 12.1, extending downwards from the lower base of the upper vessel 12; respective complementary threads are provided in said collars.

A sealing annular gasket 16 is interposed between said mutually screwed vessels 11, 12. Between the sealing gasket 16 and the bottom 12.2 of the upper vessel 12 is positioned a perforated disk-shaped filter 17, which maintains the coffee powder in the cup 14 of the funnel filter 13, while it forms an infusion chamber 17.1 with said bottom 12.2 of the upper vessel 12. Funnel filter 13 and disk-shaped filter 17 are made, for example, of aluminium.

According to the invention, in the upper vessel 12 is provided a chimney conduit 18, laterally offset relative to the axis of the coffee pot 10 and of said funnel filter 13. Said chimney conduit 18 if formed by a gap that is integral with the lateral wall of the vessel 12 and communicated with the base, through the bottom 12.2, with the underlying infusion chamber 17.1. At the top, said chimney conduit 18 has an outlet 18.1, substantially oriented towards the bottom 12.2, for the outflow under pressure of the coffee infusion. It will be noted that the outlet 18.1 is formed by a notch oriented towards the bottom of the vessel 12.

Thanks to this arrangement, a tortuous path is provided in the coffee pot 10, starting from the orifice 15.1, in which penetrates the boiling water under pressure, which impregnates and flows through the coffee powder in the chamber 14 of the funnel filter 13 and forms, collecting in the infusion chamber 17.1, the coffee infusion, which then rises to the outlet 18.1 of the laterally offset chimney conduit 18. In this way, in the cup chamber 14 and in the overlying infusion chamber 17.1 a more intense and prolonged mixing is obtained (with respect to known moka coffee pots) between boiling water under pressure, water vapour and coffee powder, forming an infusion with improved organoleptic properties.

It will be noted that the laterally offset arrangement of the chimney 18 and the shape of the outlet 18.1 oriented towards the bottom of the vessel 12 allow to convey into the vessel all the extracted coffee infusion and to avoid the harmful effects that, in known coffee pots, are caused by sprays of steam and liquid under pressure.

It should be noted that, advantageously, the gasket 16 is made of silicone for food products, a material that is less subject to thermal and mechanical wear than natural rubber or elastomers.

In said figures, the reference number 19 designates an oscillating lid, articulated to the top of the upper vessel 12, whilst the reference M designates a grip made of plastic material, fixed relative to the upper vessel 12. The reference V designates a safety valve provided in the lower vessel 11.

With reference now also to FIGS. 4 and 5, in which the parts similar to those of FIGS. 1 through 3 are indicated with the same references, the number 20 designates a mixer device, supported with respect to the lid 19 and it comprises a propeller 20.1 rotating inside the upper vessel 12 to mix together the different layers of coffee infusion that are collected in said vessel during the preparation of the drink. In said lid 19 is provided an integral bushing 20.2, coaxial relative to the axis of the coffee pot 10 and in which is mounted a corresponding rotating shaft 20.3, also coaxial relative to the axis of the coffee pot. Said shaft 20.3 extends beyond the lid 19 with its upper end, where it is provided with a grip knob 20.4. Moreover, said shaft 20.3 is axially movable relative to the bushing 20.2. The shaft 20.3 has, at the other end, four integral radial blades 20.5, arranged at 900 from each other.

Therefore, when the lid 19 is closed and the knob 20.4 is gripped, the propeller 20.1 can be made to rotate integrally with the shaft 20.3, thereby mixing the coffee infusion contained in the upper vessel 12. It should be noted that, during this operation, since the chimney conduit 18 is laterally offset relative to the axis of the vessel 12, the axial mobility of the shaft 20.3 relative to the bushing 20.2 allows to adjust the depth of the propeller 20.1 in the vessel 12, thereby improving the mixing of the infusion.

By this arrangement, it is possible to pour an infusion with equivalent organoleptic properties from the first to the last cup.

Laboratory Tests

Using a specific laboratory method, it was experimentally measured that the coffee pot of the present invention is able to extract from the coffee powder a greater quantity of coffee aroma relative to known moka coffee pots, for the same mix and dosage of water and coffee.

The method used consists of weighing the dry residue of the drink obtained from coffee pots of equal dimensions, using equal quantities of water and coffee powder.

These tests have demonstrated, with a confidence margin above 90%, that the coffee pot according to the invention is in fact more effective than conventional moka coffee pots in producing a richer tasting coffee.

As is readily apparent from the above, the coffee pot according to the invention allows to achieve the objects set out in the preamble.

1. Moka coffee pot, comprising two superposed vessels, joined together in screw-on fashion, in which the lower vessel is meant to contain water and serves as a boiler, while in it is housed a funnel filter having a cup-shaped upper chamber for coffee powder, with a perforated bottom, and a tube which extends downwards from the bottom of the cup-shaped chamber and whose orifice is positioned in proximity to the bottom of the vessel for the entrance of the water, said filter being aligned with the median vertical of the two superposed vessels (vertical hereafter called, for the sake of brevity, axis of the coffee pot), in which the upper vessel serves as a container for collecting the infusion and it is provided with a chimney conduit for the infusion under pressure coming from the boiler through the funnel filter, said conduit having an outlet positioned in the top part of the upper vessel, and in which a pressure-sealed annular gasket is provided between the two mutually screwed vessels, whilst between the gasket and the bottom of the upper vessel is positioned a perforated disk filter, which maintains the coffee powder in the cup of the funnel filter and forms with the bottom of the upper vessel an infusion chamber, with which communicates said chimney conduit, characterised in that said chimney conduit (18) is laterally offset relative to the axis (X-X) of the coffee pot (10), and in that in the coffee pot (10) tortuous path is formed, starting from said orifice (15.1), in which the boiling water under pressure enters and arrives, through the axial tube (15), in the chamber (14) of the funnel filter (13), where it impregnates and flows through the coffee powder and the disk-shaped filter (17), forming in the infusion chamber (17.1) the coffee infusion, which then rises under pressure through said offset chimney conduit (18), to its outlet (18.1), wherefrom it spills into the upper vessel (12), in such a way that in the cup chamber (14) and in the overlying infusion chamber (17.1) a more intense and prolonged mixing is obtained (relative to known moka coffee pots) between boiling water under pressure, water vapour and coffee powder, forming an infusion with improved organoleptic properties.

2. Coffee pot as claimed in claim 1, characterised in that said chimney conduit (18) is formed integrally with the lateral wall of said upper vessel (12).

3. Coffee pot as claimed in claim 1, characterised in that said outlet (18.1) is formed by a notch oriented towards the bottom of the upper vessel (12), so that the whole extracted coffee infusion is conveyed in the vessel (12) itself.

4. Coffee pot as claimed in claim 1, characterised in that it comprises a mixer device (20), supported relative to the lid (19) of the coffee pot and including a rotating propeller (20.1), which rotates, with the lid closed, inside the upper vessel (12) to mix together the different layers of coffee infusion which are collected in said vessel during the preparation of the drink.

5. Coffee pot as claimed in claim 4, characterised in that it comprises a shaft (20.3) mounted rotatable relative to said lid (19) and extending beyond the lid with one of its ends provided with a grip knob (20.4), and in that said shaft (20.3) has at least one blade (20.5) of a propeller (20.1) so that with the lid (19) closed and gripping the knob (20.4) it is possible to make the propeller (20.1) rotate integrally with the shaft (20.3) to mix the coffee infusion contained in the upper vessel (12).

6. Coffee pot as claimed in claim 4, characterised in that said shaft (20.3) is axially movable relative to said fid (19) to mix the infusion contained in the upper vessel (12) at different depths.

7. Coffee pot as claimed in claim 1, characterised in that said annular sealing gasket (16) is made of silicone for food products.
